(19) United States
(12) Patent Application Publication
(10) Pub. No.: US 2005/0055419 A1
(43) Pub. Date: Mar. 10, 2005

(54) Method and apparatus for platform independent network virtual memory (PINVM) hierarchy

(76) Inventor: Jae C. Oh, Jamesville, NY (US)

Correspondence Address: HANCOCK & ESTABROOK, LLP, 1500 MONY TOWER I, PO BOX 4976, SYRACUSE, NY, 13221-4976, US

(21) Appl. No.: 10/848,808

(22) Filed: May 19, 2004

Related U.S. Application Data
(60) Provisional application No. 60/473,633, filed on May 23, 2003.

(51) Int. Cl. G06F 15/167

(52) U.S. Cl. 709/213

(57) ABSTRACT

A thin-client/server session is established using platform independent network virtual memory (PINVM). The server contains a collection of programs that are compiled for the client architecture. The client finds a server for PINVM. The server provides the client with the list of programs as well as the size of virtual memory space that will be allowed for the client to use. The client-side daemon process adjusts the available memory size so that the client OS thinks the memory size available is as large as the virtual memory size provided by the server during the session. The network virtual memory hierarchy is established, with the server's memory and hard disk attached to the client's physical memory hierarchy. After the client selects a program to launch, the server creates a virtual address space for the client program using the network memory hierarchy established. The program can now run on the client.

### CROSS-REFERENCE TO RELATED APPLICATIONS

This application claims priority from U.S. Provisional Application Ser. No. 60/473,633 filed May 23, 2003 and entitled METHOD AND APPARATUS FOR PLATFORM INDEPENDENT NETWORK VIRTUAL MEMORY (PINVM) HIERARCHY, incorporated herein by reference.

### FIELD OF THE INVENTION

This invention relates generally to the field of software implementation, and more particularly to a establishing a memory hierarchy via a network.

### BACKGROUND OF THE INVENTION

In the current technology trends, small devices such as PDAs and laptop computers have CPUs as powerful as the ones used in servers. Even if the clock speeds are slower or on-chip cache memory sizes are smaller on PDA CPUs, the memory addressing capacity is as large as the CPUs that are used in server machines. However, because of the memory hardware limitations, the address spaces of these “thin-clients” are wasted. Typically, PDAs have 16 MB to 64 MB memory (including the flash memory), while servers can have several gigabytes of the main memory.

The idea of thin client support can be different depending on the context. Telnet provides a simple command console providing remote access to servers. This simple network connection support can be viewed as a thin-client support. X windows as described in R. W. Scheifler and J. Gettys, The x window system, ACM Transactions on Graphics, 5(2):79-109, 1986, lets a client machine run programs on computer servers and display the results on the client machine. Therefore, the graphics display is done in the client side. X windows requires the client to have the X server application running. X Windows application programs must be developed with the X Windows programming environment with appropriate X libraries.

Virtual Network Computing (VNC) as described in Tristan Richardson, Quentin Stafford-Fraser, Kenneth R. Wood, and Andy Hopper, Virtual network computing, IEEE Internet Computing, 2(1):33-38, 1998 is a remote display system that originates from the development of very-thin-client ATM network computers. It allows the screen to be viewed by any monitor in the world. The computation is done in the server machine, unlike the present invention. Microsoft Windows NT server 4.0, Terminal Server Edition, or Terminal Services in Windows 2000, and Citrix, as described in T. W. Mathers and S. P. Genoway, Windows NT Thin Client Solutions: Implementing Terminal Server and Citrix MetaFrame, Macmillan Technical Publishing, Indianapolis, Ind., 1998 send program output images to be displayed on the client and send keystrokes and mouse clicks to the remote server that runs the program. These systems can be considered to have a long monitor cable from a client to the server, which is different from the present invention.

Distributed Shared Virtual Memory (DSVM), as described in C. Morin and I. Puaut, A survey of recoverable distributed shared memory systems, IEEE Trans. On Parallel and Distributed Systems, 8(9):959-969, 1997 supports a continuous page view for a program even if its pages are scattered over the distributed system. DSVM requires a special virtual address format to identify the machine that owns the page requested. This means the hardware must support the DSVM architecture. NUMA (Non-Uniform Memory Access) or S-COMA (both of which are described in K. Hwang, Advanced Computer Architecture, McGraw-Hill, New York, 1993) memory architecture that are mostly used in MIMD machines are precursors of the DSVM system. NUMA architecture, for example, is a special computer architecture (i.e., hardware) that supports shared memory among multiprocessors. All of the above approaches either support remote display, remote access of the server's CPU, or remote memory access.

### SUMMARY OF THE INVENTION

Briefly stated, a thin-client/server session is established using platform independent network virtual memory (PINVM). The server contains a collection of programs that are compiled for the client architecture. The client finds a server for PINVM. The server provides the client with the list of programs as well as the size of virtual memory space that will be allowed for the client to use. The client-side daemon process adjusts the available memory size so that the client OS thinks the memory size available is as large as the virtual memory size provided by the server during the session. The network virtual memory hierarchy is established, with the server's memory and hard disk attached to the client's physical memory hierarchy. After the client selects a program to launch, the server creates a virtual address space for the client program using the network memory hierarchy established. The program can now run on the client.

The PINVM (platform independent network virtual memory) technology introduces a new concept called memory hierarchy via network. Computers can have arbitrary memory hierarchy through the network, attaching memory hierarchy of other computers to its own. Although we explain only the case of connecting two computers memory hierarchy through the network, this idea can be used to connect any arbitrary number of computers' memory hierarchy to each other creating a chain of network memory hierarchy. The idea is also utilized in peer-to-peer situations in that the peer computers can attach to the other computer's memory hierarchy to access programs or data stored in the other computer as if accessing their own local memory hierarchy. This approach is attractive since it uses existing virtual memory and paging technologies that are mature and stable. Since it uses the existing part or OS (operating system) as much as possible, it is to be used any OS platform and it takes advantage of existing paging and caching mechanisms and policies. PINVM can also be used in distributed computing or Grid computing where threads can migrate to a different machine. After a thread migrates to a different machine, accessing data from the original machine, where the thread was created, is network intensive. We can use PINVM in this case as well. When a thread migrates, the PINVM service can be established between the thread's home machine and the destination machine.

According to an embodiment of the invention, a method for establishing a client/server session using platform independent network virtual memory wherein the server contains a collection of programs that are compiled for the architecture of the client includes the steps of (a) finding the server for the client; (b) providing a list of the collection of programs from the server to the client; (c) providing a size of virtual memory space from the server to be allowed for the client to use; (d) adjusting, via a client side daemon process, the available memory size so that a client operating system recognizes the memory size as being as large as the virtual memory size provided by the server during the session; (e) establishing a network virtual memory hierarchy; (f) attaching the memory of the server and a hard disk of the server to the physical memory hierarchy of the client; (g) selecting, by the client, of a program to launch from within the collection of programs; and (h) creating, in the server, a virtual address space for the client program using the established network virtual memory hierarchy.

### BRIEF DESCRIPTION OF THE DRAWINGS

FIG. 1 shows a network virtual memory hierarchy established through the network.

FIG. 2 shows a general overview of interaction between a client and a server using the platform independent network virtual memory (PINVM) of the present invention.

FIG. 3 shows the flow-diagram of a client (a PDA or a laptop in this example) attaching itself to a server creating a network memory hierarchy.

FIG. 4 shows an algorithm for the client-side PINVM.

FIG. 5 shows an algorithm for a per client-application process.

### DETAILED DESCRIPTION OF THE PREFERRED EMBODIMENT

This document describes a new technology called platform independent network virtual memory (PINVM) hierarchy. PINVM can be considered to have a long memory bus between the main memory and the hard disk. PINVM is purely a software implementation and doesn't assume any special computer architecture. An application of this technology is a new way of implementing platform independent thin-clients. A small computing device such as a Personal Digital Assistant (PDA) can “attach” itself to a resource abundant server through a computer network to fully utilize the server's resources (main memory, disk, etc.) as if they are local to the PDA. This allows the small device to run large programs which it doesn't have the capability of running on its own without storing the programs locally. In other words, while a PDA is attached to a server with a large amount of main memory and disk storage, the PDA can use, with minimal network usage, the server's main memory and disk storage as its own local hardware resource. We call this the platform independent network virtual memory (PINVM) system. The technology can also be used in peer-to-peer applications allowing each computer's local memory hierarchy to attach to the peer's hierarchy. It is also possible to have chains of attached devices resulting a long virtual memory hierarchy.

In other words, through PINVM, a computing device (i.e., a client machine) can “attach” itself to a server machine via a computer network (wired or wireless) and utilize the server's main memory and disk storage as if they are local to the client. While the client is attached to the server, the server's main memory and disk storage become a part of the memory hierarchy of the client machine. The client can run any valid executable programs stored in the server's disk as if it executes its local programs. This means there is no heavy transferring of executable programs to the client in its entirety. Since the server's resources are a part of the client's resource while being connected, existing virtual memory and paging mechanisms of the client and server can be fully utilized. The client's CPU generates virtual memory addresses and page faults are generated when desired pages are not found in the local memory. The desired pages are brought into the client's memory through the network from the server's main memory or disk storage. Since the page sizes are very small, the network transfer overhead is minimal. In addition, the existing paging technology of current operating systems is extremely stable and mature in minimizing the disk access frequency. Furthermore, network speeds are usually faster nowadays than the disk access time.

PINVM is a perfect technology for so called “thin-client” applications. There are several existing ways for realizing thin-client applications including X Windows, Microsoft's Citrix, and VNC (Virtual Network Computing). PINVM is a unique and efficient way of achieving thin-client applications.

PINVM can also be used to construct a networked virtual memory hierarchy for peer-to-peer applications. Therefore, without explicitly having distributed file system or transferring the executables, PINVM allows us to access and run executables stored in a different machine locally. This idea can be also used to minimize network file access in the Grid computing or the like where processes migrate to different CPO nodes. That is, PINVM can support virtual shared memory.

PINVM also allows a virtual memory hierarchy chain over the network so that multiple computers are able to access main memory and disk storage of other machines as if accessing their own. The PINVM technology allows those small devices to connect to a server and use the server's memory hardware as if it is part of the devices' own hardware. FIG. 2 shows a general interaction between a client and a server using the PINVM technology. Thus, a device with small hardware capacity can attach itself to a server with large amounts of memory and disk storage, creating a network virtual memory hierarchy so that the server's memory and disk act as if they are parts of client's hardware.

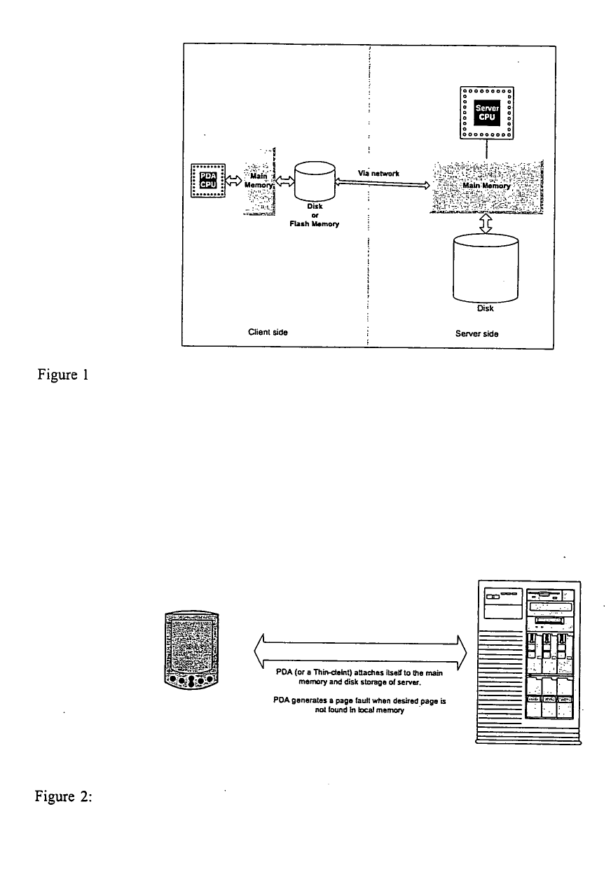

When a client is attached to a server, the server's memory hierarchy becomes a part of the client's memory hierarchy as illustrated in FIG. 1. The path along the double-arrows shows the network memory hierarchy established for the client through the network. Now the server's main memory and hard disk are parts of client's memory hierarchy. Once this hierarchy is established, the usual virtual memory paging mechanism is applied to the hierarchy. The client can now run memory intensive programs that were not possible to run before.

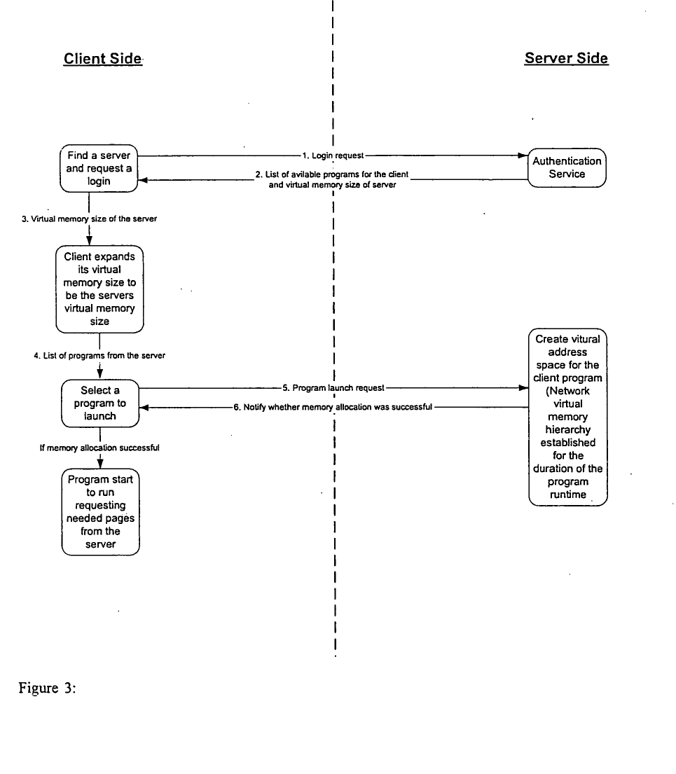

FIG. 3 shows an example flow-diagram of a thin-client/server session from the beginning to the end using the PINVM technology. The flow-diagram shows a PDA connecting to a server with a collection of programs that are compiled for the PDA architecture. The sequence of interaction is the following.

(1) The client finds a server for PINVM.

(2) After a login, the server provides the list of programs stored in the server's side for the client's architecture. The server also sends the size of virtual memory space that will be allowed for the client to use.

(3) The client side daemon process adjusts the available memory size so that the client OS thinks the memory size available is as large as the virtual memory size provided by the server during the session. The network virtual memory hierarchy is established and the server's memory and hard disk are attached to the client's physical memory hierarchy.

(4) The client selects a program to launch.

(5) The server creates a virtual address space for the client program using the network memory hierarchy established.

(6) The program can now run on the client using the network memory hierarchy.

Detailed implementation issues for the PINVM on the client-side and the server-side are now discussed. To run the PINVM service, each of the client and the server must run a daemon process. We describe the design and implementation of these daemon processes for the PINVM client and servers. We loosely make an assumption that the implementation environment is Linux because of its open source availability. However, the PINVM technology is completely platform independent. It can be implemented for any existing operating systems as well as for future operating systems. The design specification presented in this document provides detailed implementation steps for any operating system.

The client side needs a daemon process or an operating system extension (e.g., using kernel modules in Linux and DLLs in Windows) that initiates a session by connecting to a server and performs all the necessary operations for a PINVM session.

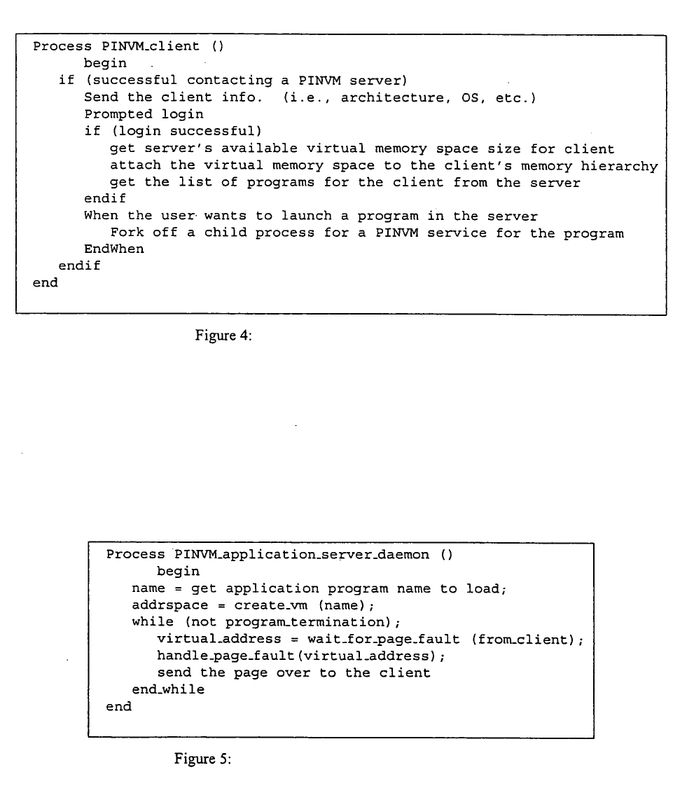

FIG. 4 shows the algorithm for the client-side PINVM daemon. The daemon is implemented as a kernel process, and for each launch of a new program, a designated child process is created. When the client disconnects itself from the server, it restores its original memory settings.

The server side runs a service daemon that monitors connection requests from potential clients. Once a request is made from a client, the server requests the client's architectural and OS information and performs an authentication process. Once a client is authenticated, the service daemon creates a client-specific child process (CSCP) designated to that client. This child process monitors any program launch request from the client. Upon receiving a program launch request from the client, this child process creates an application program service child process (APSC) that establishes network virtual memory space for the application program. In detail, APSC calls create_vm that creates a page table and other necessary components for virtual memory address translation and paging for the client's application. Note that when an APSC is created, the server's OS creates the APSC's address space as usual. Then the APSC creates the client application's address space on the server. In a sense, when a client's application needs a page, the corresponding APSC acts as if it needs that page and generates a page fault. The APSC keeps track of the page table and disk map table for the client application. When the client's page size and the server's page size are the same, one client page fault results one page fault in the server side. However, when their page sizes are different, special care must be taken. We explain this mechanism later below. FIG. 5 shows the algorithm for this daemon process.

When the page sizes for client and servers are different, we need to do a special translation to resolve this problem. The handle_page_fault (virtual_address) subroutine resolves this problem. Consider a situation where a client generates a page fault that must be serviced over the network. The needed page may be already loaded in the main memory of the server or it may be in the hard disk's swap space. In the latter situation, the server has to generate a page fault(s) to bring the desired page in the local memory. If the client's page size is twice larger than the server's page size and the page is not loaded in the server's main memory, the handle_page_fault (virtual_address) function has to generate two page faults, for example.

The following steps are taken when a PINVM client generates a page fault:

(1) A page request is transferred via the network. The request contains the virtual address of the memory access that generated the fault.

(2) The server daemon receives the request and sees if the requested page is already loaded in the main memory. This is done by the page table (PTᵢ^{j}) for the client process created when the client program started, where PTᵢ^{j} represents the page table for client i's application j.

(3) If the entire page is already in the main memory, it is just transferred to the client.

(4) If the page is not in the main memory, page faults are generated. The number of page fault to generate is

$$SAG = \frac{\frac{{x}^{2}}{{R}_{v}}}{1 + \sqrt{1 - ( 1 + k ) \frac{{x}^{2}}{{R}_{v}^{2}}}}$$

where PS_{c} and PSₛ, are the client's and the server's page sizes, respectively.

(5) Update page table information and send the page to the client.

(6) The usual page replacement, page loading algorithm, etc. is performed in the client side upon receiving the pages.

PINVM allows a client device to execute a program page by page loaded from the server machine. That is, the executable image is stored in the server machine, while the client loads pages as needed from the server machine. Thus, the client does not keep the program image locally even at the run time. PINVM uses less storage in the client side and the server doesn't need to understand how GUI is done on the client. The page sizes are usually quite small; therefore, the network overhead is relatively smaller than other approaches that transfer graphics information over the network. Also, page transfer traffic over the network can be minimized with proper paging schemes.

The following are some of the unique features of PINVM: (a) PINVM is truly platform-independent; (b) programs are executed on the client side and existing client executable programs need not be ported for PINVM, (c) no heavy graphical information is transferred over the network because only small pages are transferred, and (d) there are more choices for available executable programs for client devices. Fat-server can store the executable programs for all available platforms such as Linux kernel 2.2x, Solaris 8, HP _UX, or Windows 2000 etc. A thin-client can run the proper programs stored in the server's hard disk. PINVM enables any kind of client platform to be connected with the server. For example, a PDA running a Linux or windows CE or Pocket PC or XP embedded platform can connect to a PINVM server and run the proper programs stored in the server.

There are limitless number of applications imaginable from the PINVM technology. Possible Applications with Platform Independent Network Virtual Memory Hierarchy technology include:

(1) PINVM is a perfect technology for so called “thin-client” applications. There are several existing ways for realizing thin-client applications including X Windows, Microsoft's Citrix, and VNC (Virtual Network Computing). PINVM is a unique and an efficient way of achieving thin-client applications. There are countless applications possible using a thin-client technology. In one thin-client application, a client using PINVM can request an authentication to a PINVM server. The PINVM server stores executable programs that are compiled for the client's architecture. Clients can connect to the server by paying fees for the duration of the connection time or on a per connection basis. A PINVM client can connect to any PINVM server around the globe and run any application as long as the server provides it. Clients do not need to install any of the programs locally because clients run these programs over the network.

(2) PINVM can also be used to construct a network virtual memory hierarchy for peer-to-peer applications. Therefore, without explicitly having a distributed file system or transferring the executables, PINVM allows us to access and run executables stored in a different machine. For example, a group of small handheld devices can share memories of other devices within the group. For example, a small military unit (e.g., a platoon) or an emergency response team such as a FEMA unit, in which each member of the unit carries a handheld computer, can aggregate the computational power of all of the handhelds within the unit to run computationally demanding jobs. The member of the unit can dynamically change since all that is needed is to establish or disconnect a PINVM connection for the new or departing members.

(3) PINVM also allows a virtual memory hierarchy chain over the network so that multiple computers are able to access main memory and disk storage of other machines as if accessing their own. PINVM can also be used in distributed computing or Grid computing where threads can migrate to a different machine. After a thread migrates to a different machine, accessing data from the original machine where the thread was created is usually network intensive. When a thread migrates, the PINVM service can be established between the thread's home machine and the destination machine.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

1. A method for establishing a client/server session using platform independent network virtual memory wherein said server contains a collection of programs that are compiled for the architecture of said client, comprising the steps of:
(a) finding said server for said client;
(b) providing a list of said collection of programs from said server to said client;
(c) providing a size of virtual memory space from said server to be allowed for said client to use;
(d) adjusting, via a client side daemon process, the available memory size so that a client operating system recognizes said memory size as being as large as the virtual memory size provided by said server during said session;
(e) establishing a network virtual memory hierarchy;
(f) attaching said memory of said server and a hard disk of said server to the physical memory hierarchy of said client;
(g) selecting, by the client, of a program to launch from within said collection of programs; and
(h) creating, in said server, a virtual address space for said client program using said established network virtual memory hierarchy.

2. A method according to claim 1, further comprising the step of running said program on said client using said network virtual memory hierarchy.
